(19) United States
(12) Patent Application Publication
(10) Pub. No.: US 2007/0269560 A1
(43) Pub. Date: Nov. 22, 2007

(54) Beverage Bottle Closure Having Cap, Cover, and Confection

(75) Inventors: Leon James Scott, Atlanta, GA (US); Sergio Ribeiro Romeiro, Sao Paulo (BR)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: IN ZONE BRANDS, INC., Austell, GA (US)

(21) Appl. No.: 11/383,805

(22) Filed: May 17, 2006

(51) Int. Cl. A23B 7/148

(52) U.S. Cl. 426/106

(57) ABSTRACT

A beverage bottle closure includes a cap, a cover, and a confection. The cap attaches to a beverage bottle and has a nub extending therefrom. The confection is molded onto at least a portion of the nub or stem member of the cap. The confection defines a passage in fluid communication with an orifice of the nub so that beverage can be communicated from the bottle to the open end of the confection. The cover attaches to the cap, creating an isolated chamber between the cap and the cover and turning the cap and the cover together into a closure. A stem on an inner surface of the cover inserts into the passage in the confection and engages the orifice of the nub to prevent fluid communication between the bottle and the orifice.

### FIELD OF THE DISCLOSURE

The subject matter of the present disclosure generally relates to a closure for a beverage bottle and more particularly relates to a closure for a beverage bottle where the closure includes a cap and cover, and a confection, such as candy, attached thereto.

### BACKGROUND OF THE DISCLOSURE

Incorporating candy with a drinkable beverage can be desirable. For example, U.S. Pat. No. 6,565,899 to Cecere discloses a combination lollipop, drinking straw, and cap for a beverage bottle. In another example, U.S. Pat. No. 6,730,339 to Chan discloses a lollipop having a handle with a fluid reservoir. In yet another example, U.S. Patent Publication No. 2006/0040019 to Cecere discloses a combination bottle top beverage dispenser and candy sucker.

Having candy and a beverage incorporated together presents problems with allowing a user to enjoy the candy and beverage yet still be able to separate the physical and chemical relationship between the candy, the beverage, and the ambient environment. For example, incorporating candy and a beverage may inconveniently allow the candy and the beverage to interact with one another and with the ambient environment when they are applied to a beverage bottle and/or when they are opened for use. This can affect the shelf-life or longevity of the products.

The subject matter of the present disclosure is directed to overcoming, or at least reducing the effects of, one or more of the problems set forth above.

### SUMMARY OF THE DISCLOSURE

A beverage bottle closure includes a cap, a cover, and a confection. The cap attaches to a beverage bottle and has a nub extending therefrom. The confection is molded onto at least a portion of the nub of the cap. The confection defines a passage in fluid communication with an orifice of the nub so that beverage can be communicated from the bottle to an open end of the passage in the confection. The cover is attachable to the cap so that the cover and cap together can form a sealable closure on the beverage bottle. In forming the sealable closure, the cover attached to the cap isolates the confection in a chamber between the cap and the cover. The confection is isolated from the ambient environment outside the cover and is isolated from the beverage inside the bottle when the cover is attached to the cap. To seal the beverage in the bottle and to isolate the confection, a stem or protruding member on an inner surface of the cover has a distal end extending into the chamber of the cover. The stem inserts into the passage of the confection, and the distal end of the stem is engageable with the orifice of the nub when the cover is attached to the cap. In this way, engagement between the distal end of the stem and the orifice is intended to prevent fluid communication between the beverage bottle and the passage of the confection.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates an embodiment of a beverage bottle closure according to certain teachings of the present disclosure.

FIG. 2A illustrates an exploded view of the beverage bottle closure of FIG. 1.

FIG. 2B illustrates the beverage bottle closure of FIG. 1 in another exploded view with some of the components shown in cross-section.

FIG. 3 illustrates a cross-sectional view of the beverage bottle closure of FIG. 1 in an assembled state.

FIG. 4 illustrates a cross-sectional view of another embodiment of a beverage bottle closure in an assembled state.

FIGS. 5A through 5D illustrate a process for producing the beverage bottle closure of FIG. 1.

FIG. 6 illustrates the embodiment of the beverage bottle closure of FIG. 1 dispensing liquid.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

Referring to FIG. 1, an embodiment of a top or closure 20 according to certain teachings of the present disclosure is illustrated in a partial assembled state. The closure 20 can be used for a beverage bottle 10. The closure 20 includes a cap 30, a confection 40, and a cover 50. The cap 30 is attached to the bottle 10, and the confection 40 is attached to the cap 30. The cover 50 is removable and can be attached or detached from the cap 30. When the cover 50 is attached to the cap 30, the cap 30 and cover 50 form a sealable closure on the beverage bottle 10. In forming the sealable closure, the confection 40 is isolated from the ambient environment outside the cover 50, and the beverage in the bottle 10 is prevented from passing through the cap 30. When the cover 50 is removed as shown in FIG. 1, the confection 40 is exposed, and the beverage in the bottle 10 is allowed to pass through the cap 30 and beyond an open end 41 of the confection 40.

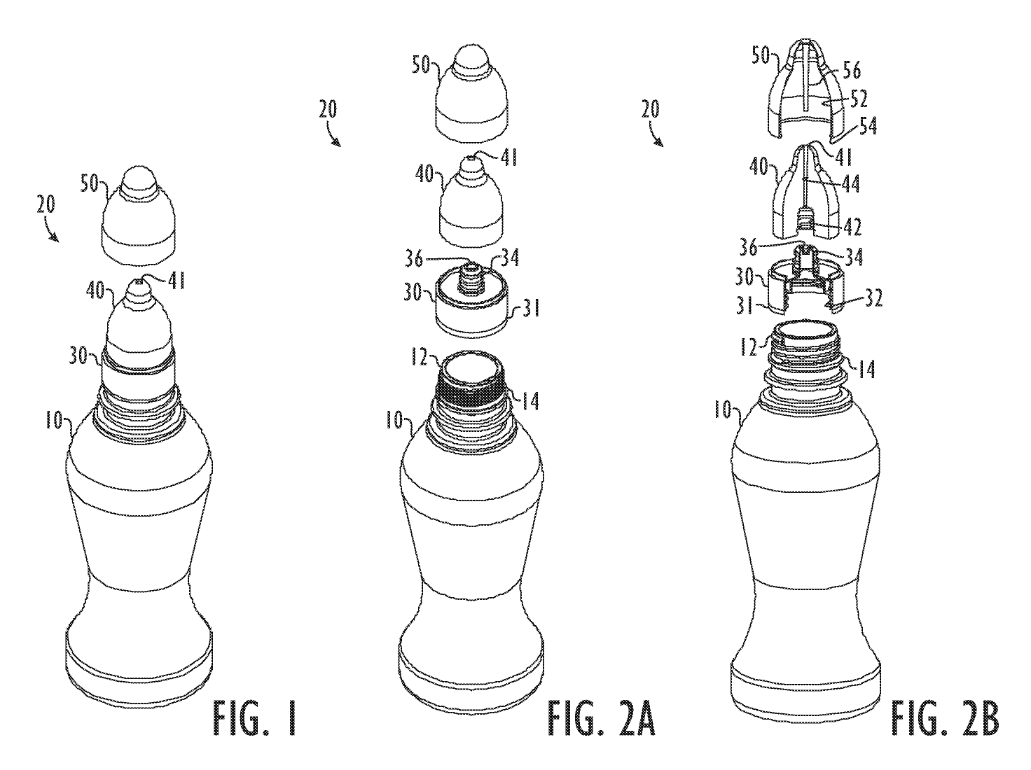

Referring to FIGS. 2A-2B, the closure 20 of FIG. 1 is shown in exploded views. For illustration, components of the closure 20 are shown in cross-section in FIG. 2B. The cap 30 has a cap protrusion or nub 34 that extends from one end of the cap 30. The cap 30 defines a passage therethrough so that the nub 34 defines an orifice 36 from which fluid of the bottle 10 can be communicated.

The cap 30 also has a thread 32 defined on an inner surface of another end of the cap 30. To hold the cap 30 onto the bottle 10, the thread 32 attaches to a complementary thread around an open end 12 of the beverage bottle 10. Preferably, the cap 30 has a breakable portion 31 around the edge of the cap 30. The breakable portion 31 fits onto a rim 14 around the open end 12 of the bottle 10. As is common in the art, this breakable portion 31 is intended to break away and remain on the rim 14 when the cap 30 is twisted off the bottle 10. Thus, the breakable portion 31 acts as a tamper resistant seal between the cap 30 and the bottle 10. In an alternative embodiment, the cap 30 may not have a breakable portion 31, and shrink wrap (not shown) can instead be applied over the outside of the cap 30, portion of the cover 50, and portion of the bottle 10 to form such a tamper resistant seal.

As best shown in FIG. 2B, a portion 42 of the confection 40 is attached to the nub 34 to hold the confection 40 on the cap 30. The confection 40 can be composed of any edible material, such as candy, chocolate, caramel, a milk product, or a food product. Preferably, the confection 40 is composed of an edible material that can be molded or formed onto the nub 34 of the cap 30. The confection 40 defines a confection passage 44 that connects the orifice 36 of the nub 34 with the end 41 of the confection 40. The confection passage 44 can be formed during the molding process or produced after molding by removing hardened material from the confection 40. In any event, the orifice 36 of the cap 30 is in fluid communication with the end 41 of the confection 40. Consequently, as a user drinks beverage from the open end 41 of the confection 40 through the confection passage 44, the beverage is allowed to interact with the confection 40, which can augment or enhance the flavor of the beverage. In addition, the user is able to mouth the outer surfaces of the confection 40 while drinking. As the user continues to consume the beverage and the confection 40, the confection 40 reduces in size. Yet, despite the fact that the confection 40 becomes smaller, the user can enjoy the confection 40 without encountering any straw portion or other tube for conveying the beverage, because the cap protrusion or nub 34 extends less than the entire length of the confection 40.

The cover 50 defines a chamber 52 with an open end 54 that attaches to the end of the cap 30. When the cover 50 is attached to the cap 30, the cover 50 fits around the confection 40 so that the confection 40 is isolated within the chamber 52. The cover 50 has a cover protrusion or stem 56. A proximate end 58 of the stem 56 is attached to an inner surface of the chamber 52, and a distal end of the stem 56 extends into the chamber 52. When the cover 50 is attached to the cap 30, this distal end of the stem 56 engages the orifice 36 of the nub 34, turning the cover 50 attached to the cap 30 into a closure that prevents fluid communication between beverage bottle 10 and the confection 40.

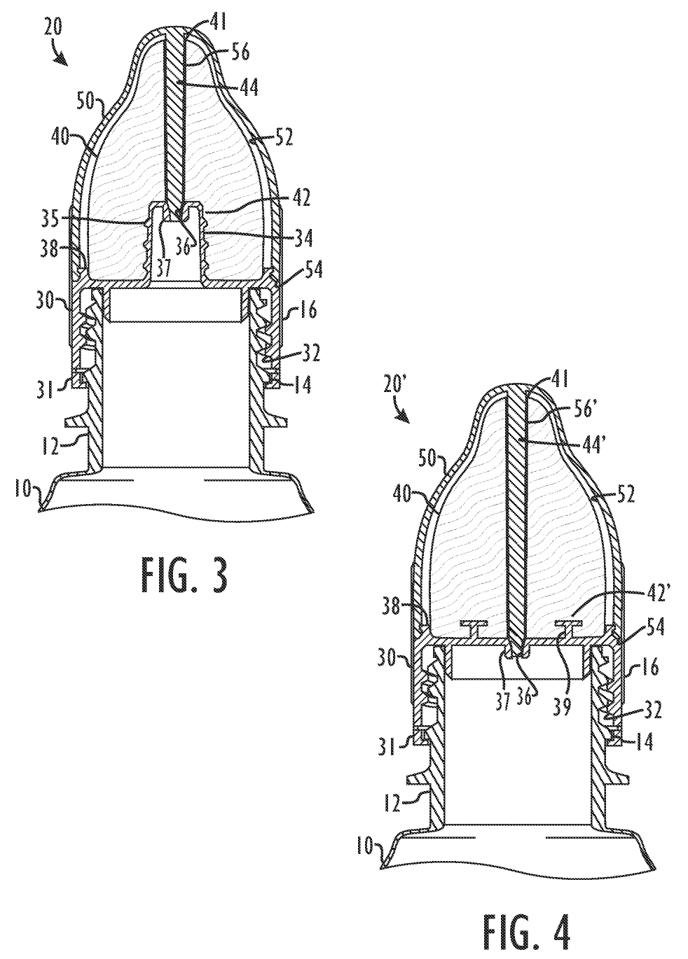

Referring now to FIG. 3, the closure 20 of FIG. 1 is shown in a more detailed cross-sectional view. The closure 20 is shown in an assembled state with the cap 30 attached to the end 12 of the bottle 10, with the confection 40 molded onto the nub 34, and with the cover 50 attached to the cap 30. The breakable portion 31 of the cap 30 is shown engaging the rim 14 of the bottle 10 in the conventional manner. Shrink wrap 16 or some other tamper proof mechanism commonly used in the art is applied around portion of the cap 30 and portion of the cover 50 to act as a temper resistant seal.

The open end 54 of the cover 50 preferably engages a rim 38 of the cap 30 when attached thereto. The nub 34 preferably has ribs or ridges 35 formed on an outer surface of the nub 34 to help hold the confection 40 when molded thereon. As evidenced in the present embodiment, the nub 34 extends less than an entire length of the confection 40, and the stem 56 of the cover 50 positions through the confection passage 44. The distal end of the stem 56 substantially seals off the orifice 36 in the nub 34 so that fluid cannot be communicated out of the bottle 10 beyond the cap 30. The orifice 36 of the nub 34 preferably has a lip 37 formed on the inner surface of the cap 30 around the orifice 36 so that the distal end of the stem 56 positions at least partially in the orifice 36 and engages an inner wall of the lip 37. The engagement between the stem 56 and the orifice 36 is intended to make a substantially fluid tight seal to prevent fluid from passing from the bottle 10 through the orifice 36. Accordingly, with the cover 50 attached, beverage is isolated from the ambient environment outside and also is not permitted to interact with the confection 40 so that the possibility of the beverage degrading, melting, etc. the confection 40 is practically eliminated. In addition, the cover 50 isolates the confection 40 from the ambient environment outside the cover 50.

The above features of the cap 30, confection 40, and cover 50 can be beneficial for the initial production and shipment of the beverage bottle closure 20. For example, the cap 30, confection 40, and cover 50 can be assembled independently and can be applied as an integrated unit to the beverage bottle 10 during production. Using the integrated cap 30, confection 40, and the cover 50 is not expected to interfere with those automatic capping procedures for beverage bottles known and used in the art.

In addition, the above features of the cap 30, confection 40, and cover 50 can be beneficial to a user of the beverage bottle 10 and closure 20. For example, the user can remove the cover 50 and can partially drink from the bottle 10 and consume the confection 40. Then, the user can reattach the cover 50, thereby sealing the bottle 10 and protecting the confection 40. In this way, the user can save the beverage and the confection 40 for later consumption without the two interacting with one another and degrading, spilling, melting, etc.

In the embodiment of the beverage bottle closure 20 of FIGS. 1 through 3, the nub 34 extends less than the entire length of the confection 40, and the stem 56 of the cover 50 positions in the passage 44 of the confection 40. Referring to FIG. 4, an alternative embodiment of a beverage bottle closure 20′ is illustrated in cross-section in an assembled state. The same reference numerals are used for the closure 20′ in FIG. 4 to indicate the same components as those found in the embodiment of FIGS. 1-3.

In this alternative embodiment, the end of the cap 30 lacks the nub (34) of FIGS. 1-3. Instead, the cap 30 defines the orifice 36 in a substantially flush end of the cap 30. Portion 42′ of the confection 40 is attached to projections or other features 39 formed on the end of the cap 30 around the orifice 36. The projections or features 39 allow the soft or liquefied material of the confection 40 to be molded or formed on the end of the cap 30 so that the confection 40 can be held to the cap 30 once the confection 40 hardens. The projections or features 39 can have any of a variety of suitable shapes. The confection passage 44′ in this embodiment extends the entire length of the confection 40 and communicates the orifice 36 in the cap 30 with the open end 41 of the confection 40. Likewise, the stem 56′ in this embodiment of the cover 50 positions in the passage 44 and extends substantially the entire length of the confection 40.

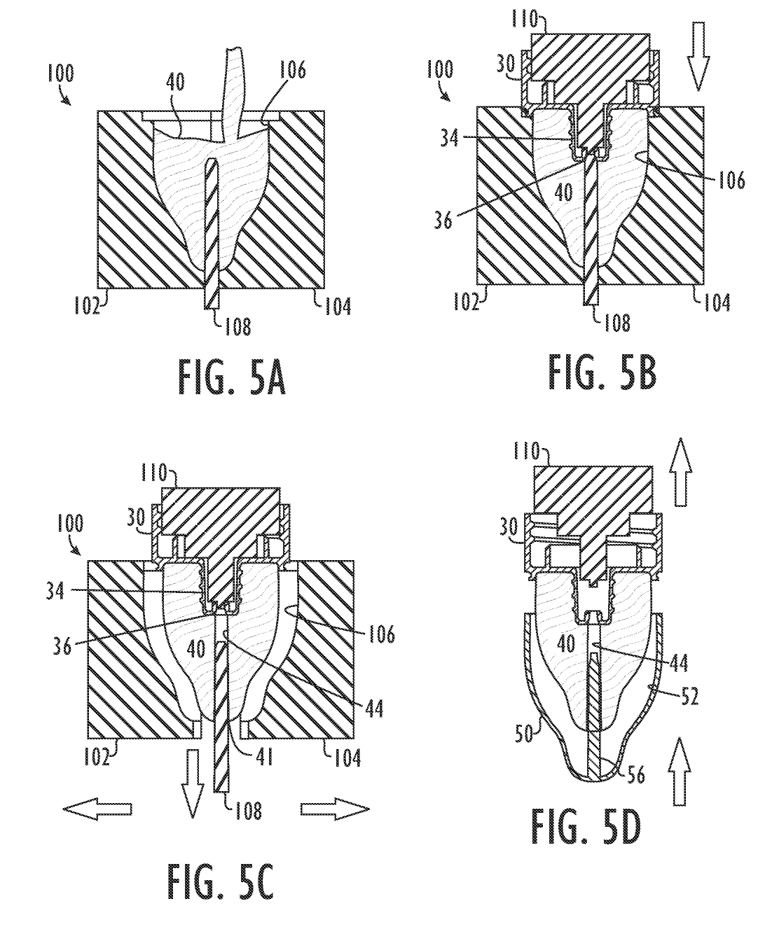

Referring to FIGS. 5A through 5D, a process for producing the closure 20 of FIGS. 1-3 is illustrated. (The process of producing the closure 20 of FIG. 4 is substantially similar.) In a first stage shown in FIG. 5A, soft or liquefied confection 40 is poured into a mold 100 having first and second halves 102 and 104. The halves 102 and 104 define a cavity 106 having the desired shape of the confection 40 when hardened. An insert 108 is positioned in the cavity 106 and is used to make the passage in the confection 40 when hardened. In an alternative embodiment, the insert 108 may not be used, and the passage can be formed in the confection 40 after hardened. In a later stage shown in FIG. 5B, the cap 30 is positioned in the open end of the cavity 106 of the mold 100 using a holder 110. Preferably, a portion of the holder 110 extends into the nub 34 of the cap 30 to close off the orifice 36. The cap 30 is positioned so that a distal end of the insert 108 positions in or makes contact with the orifice 36 in the nub 34. The liquefied confection 40 then hardens and becomes attached to the outside of the nub 34.

In a following stage shown in FIG. 5C, the halves 102 and 104 of the mold 100 are removed from the hardened confection 40. In addition, the insert 108 is removed from the hardened confection 40 leaving the resulting confection passage 44 extending from the end 41 of the confection 40 to the orifice 36 of the nub 34. In a subsequent stage shown in FIG. 5D, the cover 50 is then positioned over the confection 40 with the stem 56 fitting in the confection passage 44. Eventually, the holder 110 is removed from the cap 30, and shrink-wrap (not shown) is applied at the juncture of the cover 50 and the cap 30. In later stages, the integrated cap 30, confection 40, and cover 50 can be attached to a beverage bottle using techniques known in the art.

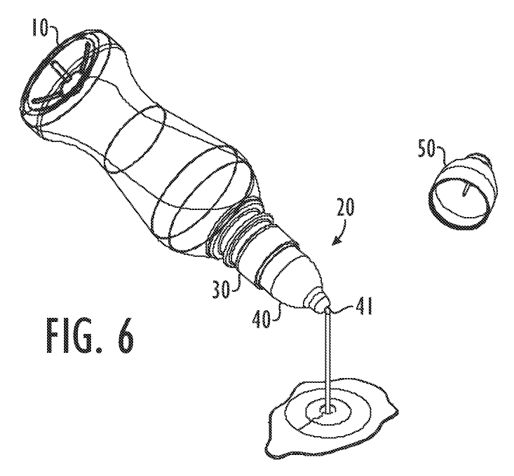

Referring to FIG. 6, the beverage bottle closure 20 of FIG. 1 is shown with the cover 50 removed and with the bottle 10 tilted. As shown in FIG. 6, beverage from the bottle 10 is preferably allowed to flow substantially freely through the cap 30 and the confection 40 so that a user can readily drink the beverage being dispensed from the open end 41 of the confection 40. Therefore, the orifice in the cap 30 and the passage in the convection 40 are preferably not designed to restrict the dispensing of the beverage where such restriction would require sucking by the user to obtain the beverage from the bottle 10. Rather, gravity may be all that is primarily needed to allow the beverage to flow freely through the cap 30 and confection 40.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A beverage bottle closure, comprising:
a cap having a first end and a second end, the second end having a nub with a distal end, the cap defining a cap passage therethrough such that the distal end of the nub defines an orifice;
a confection having a proximate end and a distal end, the proximate end positioned adjacent the second end of the cap, portion of the proximate end attached to the nub, the confection defining a confection passage communicating the orifice in the nub with the distal end of the confection; and
a removable and replaceable cover defining a chamber with an open end, the open end engageable with the second end of the cap, the cover having a stem with a proximate end attached to an inner surface of the chamber and with a distal end extending from the proximate end, the distal end of the stem insertable into the confection passage and engageable with the orifice in the nub to prevent fluid communication through the orifice.

2. The beverage bottle closure of claim 1, wherein the nub comprises ridges on an outside surface for engaging the confection.

3. The beverage bottle closure of claim 1, wherein the confection comprises a moldable material capable of attaching to the nub when molded thereon.

4. The beverage bottle closure of claim 1, wherein the distal end of the stem at least partially positions in the orifice of the nub.

5. The beverage bottle closure of claim 4, wherein the nub comprises a lip formed around the orifice, and wherein the distal end of the stem engages an inner wall of the lip.

6. The beverage bottle closure of claim 1, further comprising a beverage bottle having an open end, the first end of the cap attaching to the open end of the beverage bottle.

7. The beverage bottle closure of claim 1, wherein the orifice and the confection passage are adapted to allow the beverage from the bottle flow substantially freely from the distal end of the confection.

8. A beverage bottle closure, comprising:
a cap having a first end and a second end, the cap defining a cap passage therethrough such that the second end of the cap defines an orifice;
a confection having a proximate end attached to the second end of the cap, the confection defining a confection passage communicating the orifice in the cap with a distal end of the confection; and
a cover defining a chamber with an open end, the open end engageable with the second end of the cap, the cover having a stem with a proximate end attached to an inner surface of the chamber and with a distal end extending from the proximate end, the distal end of the stem insertable into the confection passage and engageable with the orifice in the cap to prevent fluid communication through the orifice.

9. The beverage bottle closure of claim 8, wherein the second end of the cap comprises one or more projections to which the proximate end of the confection is attached.

10. The beverage bottle closure of claim 8, wherein the second end of the cap comprises a nub having a distal end in which the orifice is defined, portion of the proximate end of the confection being attached to the nub such that the confection passage extends from the orifice in the nub to the distal end of the confection.

11. The beverage bottle closure of claim 10, wherein the nub comprises ridges on an outside surface for engaging the confection.

12. The beverage bottle closure of claim 8, wherein:
the confection passage is defined through an entire length of the confection, and
the stem is insertable into the confection passage at least through the entire length of the confection.

13. The beverage bottle closure of claim 8, wherein the confection comprises a moldable material capable of attaching to the second end of the cap when molded thereon.

14. The beverage bottle closure of claim 8, wherein the distal end of the stem at least partially positions in the orifice of the cap.

15. The beverage bottle closure of claim 14, wherein the cap comprises a lip formed around the orifice, and wherein the distal end of the stem engages an inner wall of the lip.

16. The beverage bottle closure of claim 8, further comprising a beverage bottle having an open end, the first end of the cap attaching to the open end of the beverage bottle.

17. The beverage bottle closure of claim 1, wherein the orifice and the confection passage are adapted to allow the beverage from the bottle flow substantially freely from the distal end of the confection.

18. A beverage bottle closure, comprising:
a cap defining an orifice for conveying beverage through the cap;
means for attaching the cap to a beverage bottle;
a confection having a passage for conveying beverage through the confection;
means for attaching the confection to the cap such that the orifice in the cap communicates with the passage in the confection;
a cover for forming a closure with the cap;
means for removably and replaceably covering the confection on the cap with the cover; and
means on the cover for inserting into the confection passage and sealing conveyance of beverage through the orifice in the cap when covering the confection with the cover.

19. The beverage bottle closure of claim 18, wherein the means for attaching the confection to the cap comprises means for molding the confection onto at least a portion of the cap.

20. The beverage bottle closure of claim 18, wherein the means for removably and replaceably covering the confection on the cap with the cover comprises means on the cover for engaging the second end of the cap.

21. The beverage bottle closure of claim 18, wherein:
the confection passage is defined through an entire length of the confection, and
the means on the cover for inserting into the confection passage comprises means on the cover for inserting into the confection passage at least through the entire length of the confection.

22. The beverage bottle closure of claim 18, wherein the means on the cover for inserting into the confection passage and sealing conveyance of beverage through the orifice in the cap when covering the confection with the cover comprises means on the cover for sealably engaging a first portion of the of the cover with a second portion of the cap adjacent the orifice.
